(19) United States
(12) Patent Application Publication
(10) Pub. No.: US 2009/0120981 A1
(43) Pub. Date: May 14, 2009

(54) Load-supporting device

(76) Inventors: Chris Sautter, Portland, OR (US); Mike Kemery, Portland, OR (US); Zac Elder, Portland, OR (US); Eric Roesinger, Portland, OR (US); Victor Rogers, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/217,770

(22) Filed: Jul. 7, 2008

Related U.S. Application Data
(60) Provisional application No. 60/958,570, filed on Jul. 6, 2007.

(51) Int. Cl. B60R 9/04

(52) U.S. Cl. 224/316

(57) ABSTRACT

A load-supporting device is provided for supporting and/or securing a load, such as a boat, to a vehicle. A mounting assembly may be provided for mounting the load-supporting device to a horizontal crossbar of a vehicle-mounted rack, and the mounting assembly may include one or more support pads to provide lateral support along the axis defined by the horizontal crossbar. The load-supporting device may additionally or alternatively include a support arm configured to rotate between multiple locked positions about the axis defined by the horizontal crossbar. The support arm may include at one end a securing region including both an aperture and a hook, to provide a user with options as to how the user secures a strap to the load-supporting device.

### CROSS-REFERENCE TO RELATED APPLICATIONS

This application claims priority under 35 U.S.C. § 119 from U.S. Provisional Patent Application Ser. No. 60/958,570 filed Jul. 6, 2007, which is incorporated herein by reference in its entirety for all purposes. This application also incorporates by reference in their entirety for all purposes the following U.S. Provisional Patent Applications and U.S. Patent Application: 60/958,475 filed Jul. 6, 2007, 60/958,476 filed Jul. 6, 2007, and filed Jul. 7, 2008 entitled “Load-Carrying Members for Vehicle Roofs.”

### BACKGROUND

Vehicle-mounted racks may be mounted on many types of vehicles (e.g., car, van, truck) to retain many types of loads. While vehicle-mounted racks often are mounted on the roofs of vehicles, a vehicle-mounted rack may be mounted on other parts of a vehicle, such as the trunk or rear of the vehicle. Vehicle-mounted racks may include bars, such as horizontal crossbars and/or rails, for securing and supporting loads.

Various devices may be deployed on a vehicle-mounted rack for supporting various types of loads. Examples of mounting systems for vehicle-mounted racks are found in U.S. Pat. Nos. 5,094,373, 5,685,686, 5,820,002, 5,951,231, 6,164,507, 6,283,310, 6,286,738, 6,367,673, 6,422,441, 6,425,509, 6,561,398, 6,681,971, and 7,357,283, the disclosures of which are incorporated herein by reference.

Recreational equipment including kayaks and other boats are examples of loads that may be retained by, secured by, or mounted on a vehicle-mounted rack using a load-supporting device. One example of a load-supporting device particularly well-suited for boats includes a vertical bar or support arm that is mounted on a horizontal crossbar. One or more boats may be placed on the crossbar and leaned against the support arm. Straps may be used to secure the boat(s) to the crossbars and/or support arms.

Securing or coupling the straps to the support arm may be difficult, and different users may have varying preferences as to how to accomplish this task. Existing support arms include U-shaped arms or a spike with a hook to secure the strap. Some users may add padding to the support arms or boat(s) to protect the boat(s).

### BRIEF DESCRIPTION OF DRAWINGS

FIG. 1 depicts two load-supporting devices mounted on a vehicle-mounted rack, with a boat, depicted in phantom, supported on the vehicle-mounted rack using the two load-supporting devices.

FIG. 2 is a closer view of one of the load-supporting devices of FIG. 1 shown as being pivotable about an axis defined by a horizontal crossbar.

FIG. 3 depicts two example load-supporting devices with support arms pivoted to angles transverse to the top surface of a vehicle, to better support a load on top of the vehicle.

FIGS. 4A-C depict an example support arm and a mounting assembly with recesses and a pawl being manipulated to various stages of engagement with one another to lock the support arm in various locked positions.

FIGS. 5A and B depict an example mounting assembly for mounting a load-supporting device to a vehicle-mounted rack.

### DESCRIPTION

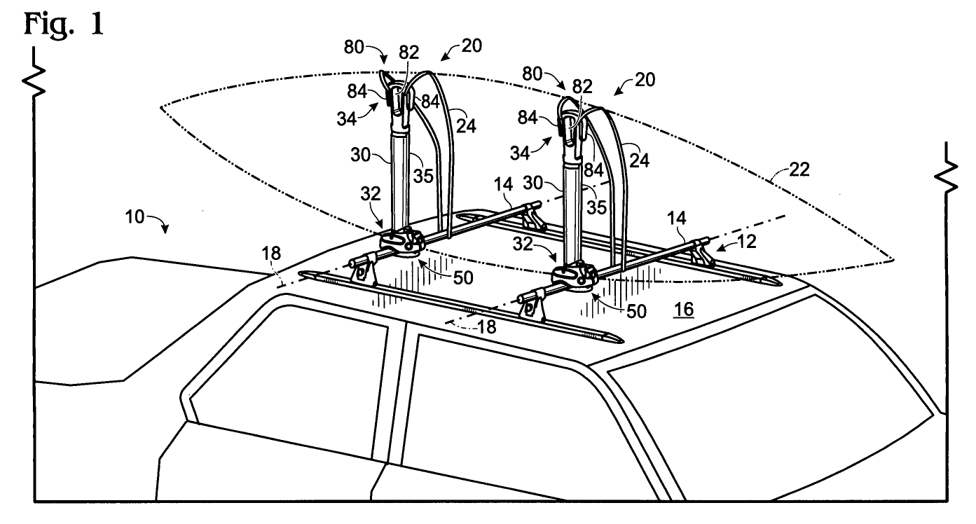

Load-supporting devices are provided herein for supporting and/or securing loads to vehicle-mounted racks. FIG. 1 shows vehicle 10 with vehicle rack 12 comprising two horizontal crossbars 14 extending over a generally planar top surface 16 of vehicle 10. Two load-supporting devices 20 are mounted on vehicle-mounted rack 12. Each load-supporting device 20 includes a support arm 30, and is mounted on horizontal crossbar 14 with a mounting assembly 50. The two load-supporting devices 20 may be identical, and the following discussion will refer generally to a single load-supporting device 20.

Boat 22 is shown in phantom being supported by and/or secured to load-supporting device 20 using one or more straps 24. It should be appreciated that load-supporting devices 20 are not limited to use with boats, and may be adapted and used for any type of load, including recreational equipment for skiing, camping, boating, hiking, sailing, flying and traveling. For example, the load-supporting devices may be provided for carrying skies, snowboards, surfboards, kayaks, bicycles, etc. Load-supporting devices 20 may also be adapted to support non-recreational loads, such as cargo baskets, cargo boxes, luggage, tool boxes, ladders, tools, and the like.

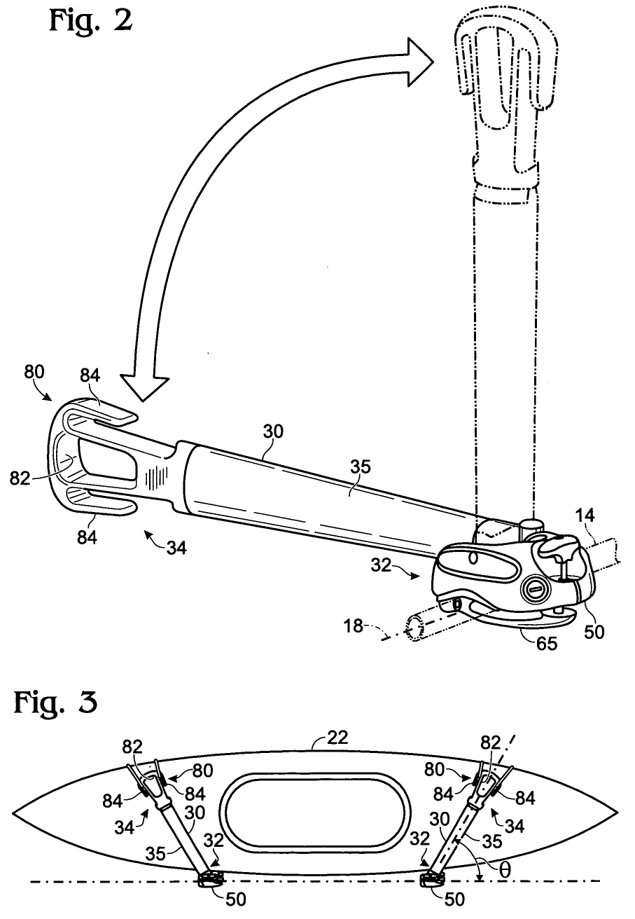

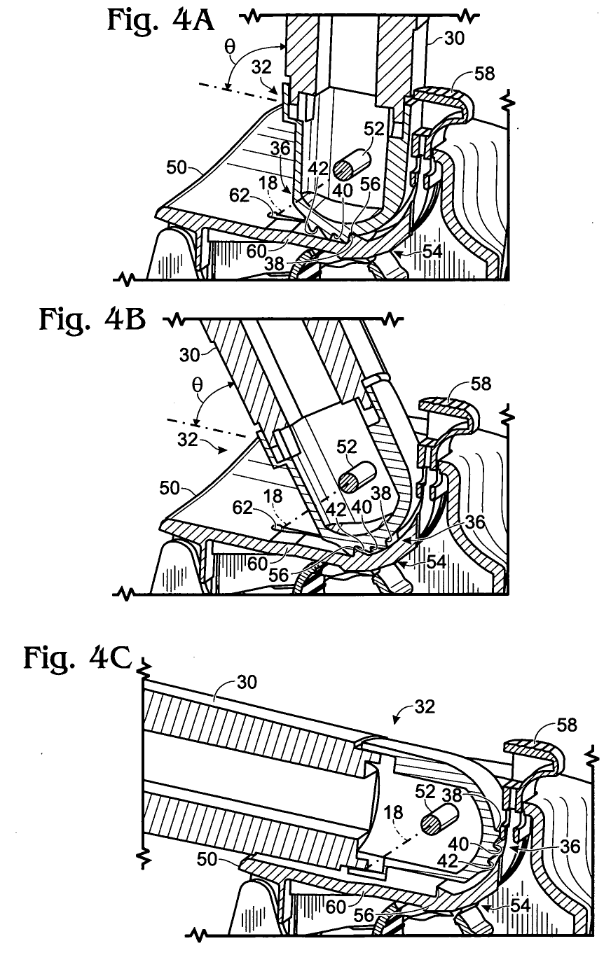

FIG. 2 shows load-supporting device 20 in detail. Support arm 30 includes a first end 32 attached to mounting assembly 50 and a second end 34 opposite first end 32. Support arm 30 may be pivotally attached to mounting assembly 50 so that support arm 30 is pivotable relative to mounting assembly 50 about an axis 18 defined by horizontal crossbar 14, on which load-supporting device 20 is mounted. In some embodiments, support arm 30 is attached to mounting assembly 50 via a pivot shaft 52 (see FIGS. 4A-C), which may be generally parallel to axis 18.

In some embodiments, support arm 30 may be pivotable between multiple locked positions. FIG. 3 depicts an example of two support arms 30 arranged at angled locked positions, in order to provide customized support for the particular shape of boat 22. Alternatively, support arms 30 may be mounted on crossbars to permit pivoting inward.

Support arm 30 may be pivotally attached to mounting assembly 50 in various ways to be pivotable between multiple locked positions. One of the mounting assembly or support arm may include at least two recesses, and the other of the mounting assembly or support arm may include a pawl configured to engage one of the at least two recesses to maintain support arm 30 in a locked position.

In the example shown in FIGS. 4A-C, a portion 36 of support arm 30 adjacent first end 32 that interacts with mounting assembly 50 includes a first recess 38, a second recess 40 and a third recess 42. Other embodiments may have more or less recesses.

Included on an area 54 of mounting assembly 50 for receiving support arm 30 is a pawl 56 sized to engage a recess such as first recess 38, second recess 40, or third recess 42. Accordingly, support arm 30 is pivotable between various locked positions. For example, in a first locked position, pawl 56 engages first recess 38 and support arm 30 is maintained generally perpendicular to generally planar top surface 16 of vehicle 10 (see FIG. 4A). In other positions where pawl 56 engages second recess 40 or third recess 42, support arm 30 is maintained at an angle Θ relative to generally planar top surface 16 of vehicle 10, with Θ being between 0° and 90° (see FIG. 4B). Support arm 30 also may be pivotable to a position wherein it is maintained generally parallel to generally planar top surface 16 of vehicle 10 (see FIG. 4C).

Although FIGS. 4A-C only show a single pawl 56, it should be understood that more than one pawl 56 may be included with load-supporting device 20 to engage more than one recess simultaneously. Moreover, while pawl 56 is shown on mounting assembly 50 and the recesses on support arm 30, pawl 56 may be instead on support arm, and the recesses may be part of mounting assembly 50.

Mounting assembly 50 may include a disengagement mechanism 58 adapted to be actuated to disengage pawl 56 from a recess such as first recess 38, second recess 40, or third recess 42, allowing support arm 30 to freely pivot about axis 18. In the example shown in FIGS. 4A-C, mounting assembly 50 includes a flexible portion 60 that is spaced from the rest of mounting assembly 50 by a separation 62. When actuated, disengagement mechanism 58 biases flexible portion 60 downwards, thereby disengaging pawl 56 from any of the first, second or third recesses, which allows support arm 30 to pivot freely about axis 18.

In some embodiments, pawl 56 and recesses (e.g., 38, 40, 42) may be shaped and/or configured to operate together as a ratchet mechanism. Rotation in one direction may be possible, and pawl 56 may snap into each recess as support arm 30 is pivoted about axis 18. Rotation in the opposite direction may not be possible without disengaging pawl 56 from the recesses.

In some embodiments, support arm 30 includes a padded portion 35 (FIGS. 1-3) to prevent or minimize damage to a load (e.g., boat 22) supported by load-supporting device 20. Padded portion 35 may be comprised of any number of different materials of varying resiliency, such as foam.

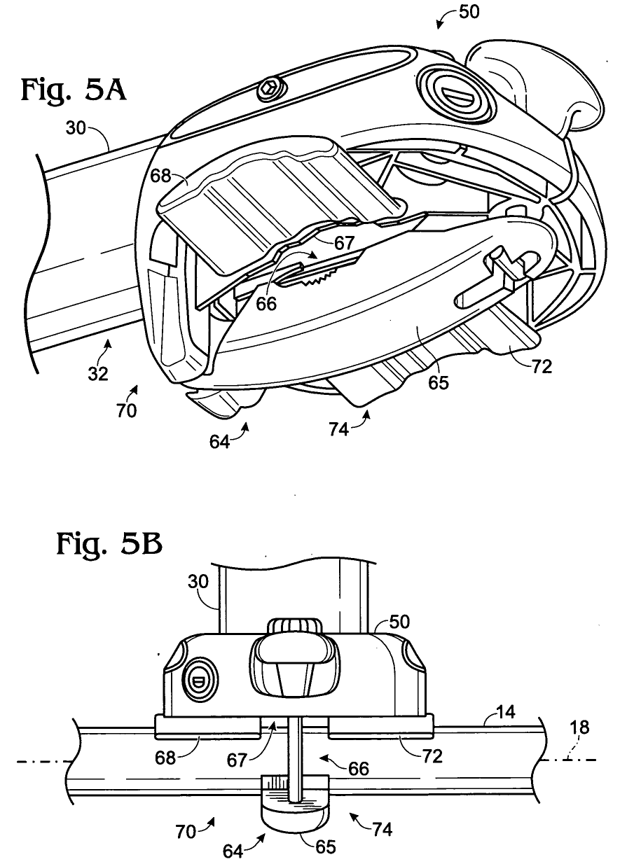

In another aspect, mounting assembly 50 may be provided with one or more support pads to provide lateral support along axis 18. An example mounting assembly 50 having support pads is shown in FIGS. 5A and 5B.

Mounting assembly 50 may include an adjustable clamp 64 defining a crossbar-receiving area 66 for receiving crossbar 14. The example mounting assembly 50 shown in FIGS. 5A and B includes an adjustable clamp 64 comprising a bottom jaw 65 and a top jaw 67 defining crossbar-receiving area 66 therebetween. Crossbar 14 may be elliptical, square, round, rectangular, or of any other cross-sectional shape, and may come in various sizes. Accordingly, adjustable clamp 64 and/or crossbar-receiving area 66 may be configured and/or shaped to receive various dimensionally different crossbars. Examples of adjustable clamps are shown in U.S. Pat. Nos. 6,442,441 and 6,681,971, and 7,357,283, which were incorporated by reference above.

Returning to the example of FIGS. 5A and B, a first support pad 68 is disposed on mounting assembly 50 adjacent to adjustable clamp 64. First support pad 68 may be configured to sit on crossbar 14 to support the load-supporting device on crossbar 14. As bottom jaw 65 of adjustable clamp 64 exerts upwards force upon the bottom of crossbar 14, top jaw 67 and/or first support pad 68 simultaneously are forced against the top of crossbar 14. The more force exerted by bottom jaw 65 on crossbar 14, the more first support pad 68 presses against crossbar 14. In some embodiments, top jaw 67 does not contact crossbar 14 directly because first support pad 68 is situated more closely to crossbar 14 than top jaw 67.

At least a portion of first support pad 68 may be outside of crossbar-receiving area 66 on one side 70 of adjustable clamp 64. In embodiments such as the example in FIGS. 5A and B, first support pad 68 is entirely outside of crossbar-receiving area 66. In other embodiments, first support pad 68 extends from one side 70 of the adjustable clamp along axis 18 defined by crossbar 14 through crossbar-receiving area 66 to a second opposite side 74 of the clamp.

Some embodiments, including the example shown in FIGS. 5A and B, include a second support pad 72 on the second opposite side 74 of adjustable clamp 64. As was the case with first support pad 68, second support pad 72 may be at least partially, or even entirely, outside of crossbar-receiving area 66. In some embodiments, second support pad 72 is identical to first support pad 68.

Support pads may be removable from mounting assembly 50. Additionally or alternatively, support pads may be movably coupled to mounting assembly 50 so that they are movable relative to crossbar 14. For example, first support pad 68 and/or second support pad 72 may be movable about axis 18. Additionally or alternatively, first support pad 68 and/or second support pad 72 may be movable along axis 18.

Users of load-supporting device 20 may prefer to secure or couple strap 24 (see FIG. 1) to load-supporting device 20 in various ways. Some users may prefer securing strap 24 to load-supporting device 20 using an aperture, and other users may prefer securing strap 24 to load-supporting device 20 using a hook.

Accordingly, the example load-supporting device 20 shown in FIGS. 1-3 is configured to allow flexibility in the manner in which one or more straps 24 are secured or coupled to load-supporting device 20. Support arm 30 has a securing region 80 adjacent its second end 34. Securing region 80 may include at least one aperture 82 and at least one hook 84. Aperture 82 and/or hook 84 may be used to couple strap 24 to load-supporting device 20.

In some embodiments, such as the one depicted in FIGS. 1-3, securing region 80 includes two hooks 84 and one aperture 82. Strap 24 is shown wrapped around two hooks 84 and fed back to crossbar 14 around boat 22 to secure boat 22 to load-supporting device 20. It should be understood that strap 24 may be wrapped around hook 84 and/or through aperture 82 in many different ways to couple strap 24 to load-supporting device 20.

The various structural members disclosed herein may be constructed from any suitable material, or combination of materials, such as metal, plastic, nylon, plastic or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

We claim:

1. A load-supporting device comprising:
a mounting assembly comprising:
an adjustable clamp defining a crossbar-receiving area for securing the load-supporting device to a crossbar on top of a vehicle; and
a first support pad adjacent the clamp, wherein at least a portion of the first support pad is outside of the crossbar-receiving area on one side of the adjustable clamp, the first support pad being configured to sit on the crossbar to support the load-supporting device on the crossbar;
a support arm attached to the mounting assembly at a first end of the support arm; and
a securing region on a second end of the support arm opposite the first end for coupling a strap to the load-supporting device.

2. The load-supporting device of claim 1, wherein the first support pad is entirely outside of the crossbar-receiving area on the one side of the adjustable clamp.

3. The load-supporting device of claim 1, wherein the mounting assembly further comprises a second support pad adjacent the adjustable clamp on an opposite side of the adjustable clamp from the first support pad.

4. The load-supporting device of claim 1, wherein the first support pad extends from the one side of the adjustable clamp along an axis defined by the crossbar through the crossbar-receiving area to a second opposite side of the adjustable clamp.

5. The load-supporting device of claim 2, wherein the adjustable clamp comprises a top jaw and a bottom jaw defining the crossbar-receiving area therebetween, and the top jaw does not contact the crossbar when the adjustable clamp is securing the load-supporting device to the crossbar.

6. The load-supporting device of claim 1, wherein the first support pad is removable from the mounting assembly.

7. The load-supporting device of claim 1, wherein the first support pad is shaped to fit the crossbar.

8. The load-supporting device of claim 1, wherein the first support pad is movably coupled to the mounting assembly so that the first support pad is movable relative to the crossbar.

9. The load-supporting device of claim 8, wherein the first support pad is movable about an axis parallel to the crossbar.

10. The load-supporting device of claim 8, wherein the first support pad is movable along an axis defined by the crossbar.

11. The load-supporting device of claim 1, wherein the mounting assembly further comprises a pivot shaft, and the support arm is pivotally attached to the pivot shaft so that the support arm is pivotable about an axis defined by the crossbar between at least two locked positions.

12. The load-supporting device of claim 11, wherein the securing region includes an aperture and a hook for coupling the strap to the load-supporting device.

13. A load-supporting device comprising:
a mounting assembly for mounting the load-supporting device to a crossbar on top of a vehicle, the mounting assembly including a pivot shaft;
a support arm pivotally attached to the pivot shaft at a first end of the support arm, the support arm being pivotable about an axis parallel to the crossbar between at least two locked positions; and
a securing region on a second end of the support arm opposite the first end for coupling a strap to the load-supporting device.

14. The load-supporting device of claim 13, wherein one of the mounting assembly or support arm further comprises at least two recesses, and the other of the mounting assembly or support arm further comprises a pawl configured to engage one of the at least two recesses to maintain the support arm in a locked position.

15. The load-supporting device of claim 14, wherein in one of the at least two locked positions, the support arm 30 is maintained at an angle Θ relative to a generally planar top surface of the vehicle, with Θ being between 0° and 90°.

16. The load-supporting device of claim 15 further comprising a disengagement mechanism adapted to be actuated to disengage the pawl from any one of the at least two recesses, allowing the support arm to freely pivot about the axis.

17. The load-supporting device of claim 16, wherein the pawl is flexibly disposed on the mounting assembly, and the disengagement mechanism is configured to move the pawl away from the at least two recesses upon actuation.

18. The load-supporting device of claim 13 further comprising a ratchet mechanism for moving the support arm between and maintaining the support arm in the at least two locked positions, the ratchet mechanism comprising at least two recesses on one of the mounting assembly or the support arm, and a pawl on the other of the mounting assembly or support arm, the pawl being sized to engage any one of the at least two recesses.

19. The load-supporting device of claim 13, wherein the support arm includes a padded portion.

20. The load-supporting device of claim 13, wherein the securing region includes an aperture and a hook for coupling the strap to the load-supporting device.

21. The load-supporting device of claim 20, wherein the mounting assembly further comprises:
an adjustable clamp defining a crossbar-receiving area for securing the load-supporting device to the crossbar on top of the vehicle; and
a first support pad disposed on the mounting assembly adjacent the adjustable clamp so that at least a portion of the first support pad is outside of the crossbar-receiving area on one side of the adjustable clamp, the first support pad being configured to sit on the crossbar to support the load-supporting device on the crossbar.

22. A load-supporting device comprising:
a mounting assembly for mounting the load-supporting device to a crossbar;
a support arm attached to the mounting assembly at a first end of the support arm; and
a securing region on a second end of the support arm opposite the first end, the securing region including an aperture and a hook for coupling a strap to the load-supporting device.

23. The load-supporting device of claim 22, wherein the mounting assembly further comprises:
an adjustable clamp defining a crossbar-receiving area for securing the load-supporting device to the crossbar on top of a vehicle; and
a first support pad disposed on the mounting assembly adjacent the adjustable clamp so that at least a portion of the first support pad is outside of the crossbar-receiving area on one side of the adjustable clamp, the first support pad being configured to sit on the crossbar to support the load-supporting device on the crossbar.

24. The load-supporting device of claim 23, wherein the mounting assembly further comprises a pivot shaft, and the support arm is pivotally attached to the pivot shaft so that the support arm is pivotable about an axis defined by the crossbar between at least two locked positions.
